(19) United States
(12) Patent Application Publication
(10) Pub. No.: US 2006/0146412 A1
(43) Pub. Date: Jul. 6, 2006

(54) Image sensor having square microlens

(75) Inventor: Sang Sik Kim, Suwon-city (KR)

Correspondence Address: MCKENNA LONG & ALDRIDGE LLP, 1900 K STREET, NW, WASHINGTON, DC, 20006, US

(73) Assignee: DONGBUANAM SEMICONDUCTOR INC., Kangnam-Ku (KR)

(21) Appl. No.: 11/320,465

(22) Filed: Dec. 29, 2005

(30) Foreign Application Priority Data
Dec. 30, 2004 (KR) 10-2004-0116511

(51) Int. Cl. G02B 27/10

(52) U.S. Cl. 359/622

(57) ABSTRACT

An image sensor includes a color filter layer including a plurality of color filters forming a color filter array of two dimensions; an inner lens layer, disposed below the color filter layer, the inner lens layer including a plurality of inner lenses arranged in a striped pattern in correspondence to a first dimension of the color filter array; and a microlens layer, disposed above the color filter layer, the microlens layer including a plurality of microlenses arranged in a striped pattern in correspondence to a second dimension of the color filter array, each microlens layer having a curved upper surface for focusing light. Thus, the incident light through the condensing lens is induced to photodiodes so as to reduce light loss and improve photosensitivity.

### CROSS-REFERENCE TO RELATED APPLICATION

This application claims the benefit of Korean Patent Application No. 10-2004-0116511, filed on Dec. 30, 2004, which is hereby incorporated by reference as if fully set forth herein.

### BACKGROUND OF THE INVENTION

1. Field of the Invention

The present invention relates to an image sensor, and more particularly, to an image sensor having a square microlens, in which lens layers are criss-crossed in a striped pattern below and on color filter layers to form one condensing lens such that incident light through the condensing lens is directed to photodiodes to reduce light loss and improve photosensitivity.

2. Discussion of the Related Art

In fabricating an image sensor, resolution is determined by the number of photodiodes arranged in an image plane. Therefore, there is the trend toward a higher number of pixels and the resulting miniaturization of the unit pixel in the image sensor. In condensing external images to the image plane, the size of the unit pixel becomes small and a portion of that pixel that receives light is reduced, thereby reducing photosensitivity. To enhance photosensitivity, a condensing lens is used.

The condensing lens is formed below or on color filter layers. Since condensing efficiency of incident light depends on a sectional area of the condensing lens, the area of the condensing lens is maximized to condense more light to reduce uncondensed light in order to reduce a phase signal, thereby obtaining images of high resolution.

As described above, with miniaturization and a multi-pixel structure of the image sensor, more pixels per unit area are formed. With the decrease of the pixel size, the sizes of color filter layers and a microlens layer formed in an on-chip type is also reduced. As the size of unit pixel becomes smaller, a photodiode area that receives light is reduced, thereby reducing photosensitivity. To compensate for reduced photosensitivity, an inner lens is additionally formed. In this case, the inner lens induces the incident light to adapt to the variation of a condensing angle due to F-number and compensates stray light due to a long distance from the photodiode area. Alternatively, the size of the microlens is maximized to compensate for reduced photosensitivity.

The microlens can be essentially formed with a square shape. However, it is difficult to form the square shaped microlens because the characteristics that minimize a surface area around a diagonal line in a lattice structure also tend to form a round shape. Also, since the microlens has a round shape due to the optical effect when images are formed, a portion where the microlens is not formed increases in a diagonal line. For this reason, loss of incident light occurs along with the scattering of the incident light, and the incident light enters again into an adjacent pixel to serve as a phase signal that deteriorates resolution.

### SUMMARY OF THE INVENTION

Accordingly, the present invention is directed to an image sensor having a square microlens that substantially obviates one or more problems that may be due to limitations and disadvantages of the related art.

The present invention can provide an image sensor having a square microlens, in which lens layers are criss-crossed in a striped pattern below and on color filter layers to form a condensing lens so that incident light through the condensing lens is directed to the photodiodes to reduce light loss and improve photosensitivity.

Additional advantages and features of the invention will be set forth in part in the description which follows and in part will become apparent to those having ordinary skill in the art upon examination of the following. These and other advantages of the invention may be realized and attained by the structure particularly pointed out in the written description and claims hereof as well as the appended drawings.

To achieve these and other advantages, as embodied and broadly described herein, there is provided an image sensor comprising a color filter layer including a plurality of color filters forming a color filter array of two dimensions; an inner lens layer, disposed below the color filter layer, the inner lens layer including a plurality of inner lenses arranged in a striped pattern in correspondence with a first dimension of the color filter array; and a microlens layer, disposed above the color filter layer, the microlens layer including a plurality of microlenses arranged in a striped pattern in correspondence with a second dimension of the color filter array, each microlens layer having a curved upper surface for focusing light.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention illustrate embodiments of the invention and together with the description serve to explain the principle of the invention. In the drawings:

FIGS. 1 and 2 are sectional views of a contemporary black-and-white image sensor, including a planarization layer;

FIG. 3 is a perspective structural view of an image sensor according to the present invention;

FIG. 4 is a plan view of an image sensor according to the present invention;

FIG. 5 is a sectional view along line V of FIG. 4;

FIG. 6 is a sectional view along line VI of FIG. 4;

FIG. 7 is a plan view for illustrating a glossy area in a related art image sensor; and

FIG. 8 is a plan view for illustrating a low loss area in an image sensor according to the present invention.

### DETAILED DESCRIPTION OF THE INVENTION

Reference will now be made in detail to exemplary embodiments of the present invention, examples of which are illustrated in the accompanying drawings. Wherever possible, like reference designations will be used throughout the drawings to refer to the same or similar parts.

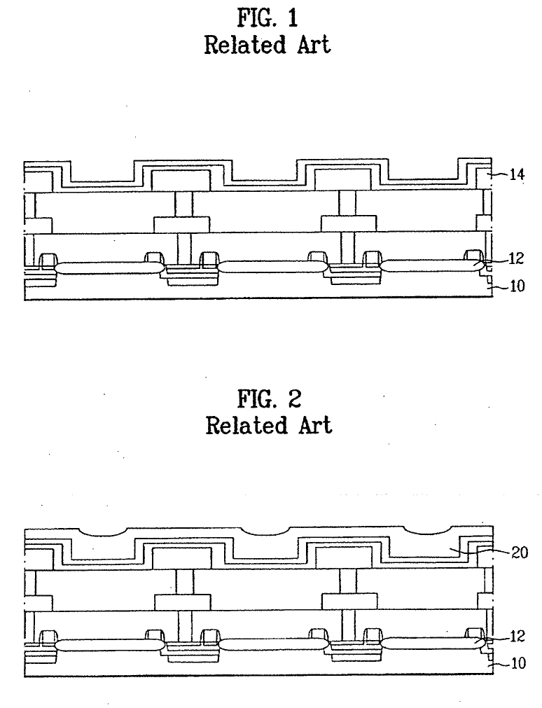

FIGS. 1 and 2 illustrate the basic lower structure of an image sensor, which is formed by process steps for completing what is commonly referred to as a black-and-white image sensor, i.e., an image sensor without a color filter array for color filtering and color separation. A color filter array typically occupies one layer, i.e., a color filter layer, and is comprised of a plurality of colors filters arranged in two dimensions or directions, for example, along an x axis and a y axis.

An image sensor can be formed by typical process steps of a CMOS or CCD such that photodiodes 12 are formed on a silicon wafer 10 and divided per pixel by metal layers 14. Color filter layers are formed in the image sensor in an on-chip type to enable color filtering and color separation. The image sensor is formed on the silicon wafer in a CCD or CMOS type by the typical process steps. A planarization layer 20 is formed of an organic material having good transparency within a visible wavelength region to improve the profile and uniformity of the color filter layers in a state that the upper portion of the image sensor is passivated.

The image sensor of the present invention includes a color filter layer, which is sandwiched between a striped pattern of inner lenses, occupying one layer and disposed immediately below the color filter layer, and a striped pattern of microlens layers, occupying one layer and disposed immediately above the color filter layer. The inner lens layer 30 is formed on the planarization layer 20.

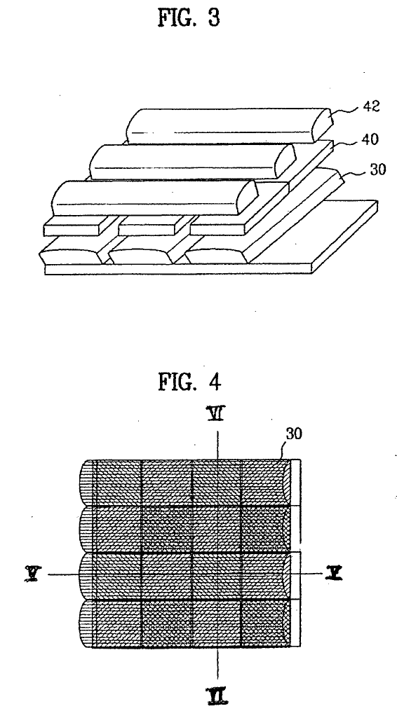

Referring to FIG. 3, an image sensor according to the present invention includes an inner lens layer 30 disposed below a color filter layer 40 and a microlens layer 42 formed on the color filter layer. Each striped section of the inner lens layer 30 and the microlens layer 42 has an upper surface with a predetermined curvature for focusing light. The sections of the inner lens layer 30 perpendicularly cross the sections of the microlens layer 42 to form a square intersections corresponding to the size of a pixel.

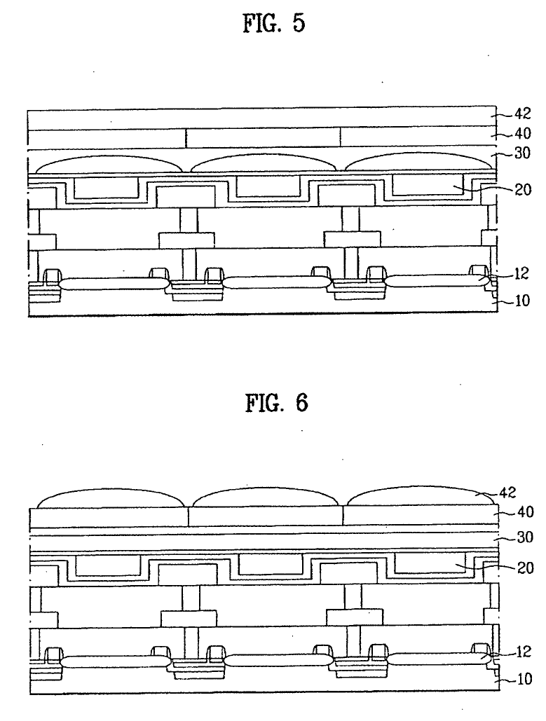

Referring to FIGS. 4-6, photodiodes 12 are formed on a silicon wafer 10, and a planarization layer 20 is formed above the photodiodes 12. The color filter layers 40 are formed between the inner lens layers 30 and the microlens layers 42.

To fabricate the image sensor according to the present invention, the image sensor is formed on the silicon wafer in accordance with a CCD or CMOS type by typical process steps. The planarization layer is formed of an organic material having a good transparency within a visible wavelength region to improve the profile and uniformity of the color filter layers such that the upper portion of the image sensor is passivated. After the planarization layer is formed, a photoresist with good fluidity is coated at a predetermined thickness in the process of forming the inner lens layers. The thickness of the photoresist depends on the size of the pixel and the thickness of the layer to be coated with the photoresist. Generally, the photoresist can be coated at a thickness of about 0.5 μm to about 1.5 μm. The inner lens layers are formed with a striped pattern in a horizontal or vertical direction as seen in a plan view. The striped pattern of the inner lens layers is formed to cross that of the microlens layers. In other words, if the inner lens layers are formed in columns, the microlens layers on the color filter layers are formed in rows.

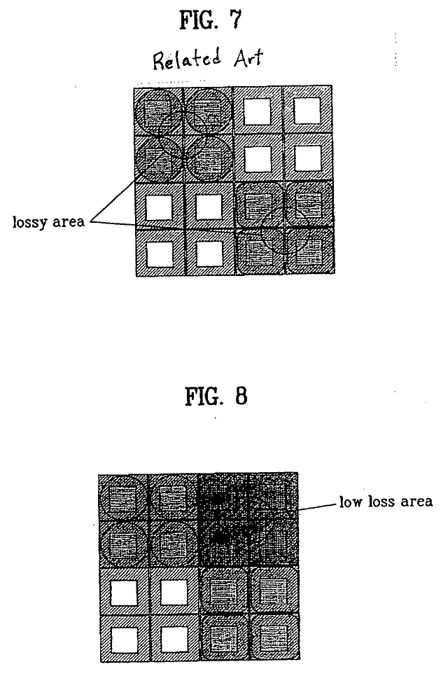

FIGS. 7 and 8 compare the contrasting microlens structures in a related art image sensor and the image sensor according to the present invention, respectively, highlighting the elimination of the glossy area present in FIG. 7.

After the inner lens layers are formed with a stripe shape, a first overcoating layer is formed from a transparent polyimide material to planarize the uneven portions of the inner lens layers. The color filter layers are then formed by a predetermined process. Finally, a second overcoating layer is selectively formed to improve planarization, control a focal length, and protect the color filter layers, thereby forming the striped shaped microlens. Thus, the striped shaped microlens is formed to two-dimensionally cross the inner lens. Thus, a double striped shaped microlens is formed. Instead of a microlens having a square shape but having a diagonal corner that cannot be used, one condensing lens is formed below and on the color filter layers by crossing the lens layers in a striped shape. Thus, the incident light through the condensing lens is induced to the photodiodes so as to reduce light loss and improve photosensitivity.

It will be apparent to those skilled in the art that various modifications can be made in the present invention without departing from the spirit or scope of the invention. Thus, it is intended that the present invention covers such modifications provided they come within the scope of the appended claims and their equivalents.

1. An image sensor, comprising:
a color filter layer including a plurality of color filters forming a color filter array;
an inner lens layer below said color filter layer, said inner lens layer including a plurality of inner lenses arranged in a striped pattern in a first direction; and
a microlens layer above said color filter layer, said microlens layer including a plurality of microlenses arranged in a striped pattern in a second direction, each microlens layer having a curved upper surface for focusing light.

2. The image sensor as claimed in claim 1, wherein the first direction is perpendicular to the second direction.

3. The image sensor as claimed in claim 2, wherein the striped pattern of said microlens layer and the striped pattern said inner lens layer forms a plurality of square intersections, each intersection corresponding to a pixel.

4. The image sensor as claimed in claim 1, wherein each microlens of the striped pattern of said microlens layer and each inner lens of the striped pattern of said inner lens layer have equal widths.

5. The image sensor as claimed in claim 1, wherein said inner lens layer has a thickness of about 0.5 μm to about 1.5 μm.

6. The image sensor as claimed in claim 1, wherein said microlens layer has a thickness of about 0.5 μm to about 1.5 μm.

7. The image sensor as claimed in claim 1, further comprising an overcoating layer formed on the inner lens layer.

8. The image sensor as claimed in claim 1, further comprising an overcoating layer formed on the color filter layer.

9. A method for fabricating an image sensor having a color filter layer sandwiched between an inner lens layer formed immediately below the color filter layer and a microlens layer formed immediately above the color filter layer, the method comprising:
coating the inner lens layer with a photoresist layer having a striped pattern arranged in a first direction of a two-dimensional array of pixels;
forming the color filter layer above the overcoating layer; and
coating the color filter layer with a photoresist layer having a striped pattern arranged in a second direction of the two-dimensional array of pixels.

10. The method as claimed in claim 9, further comprising:
forming a first overcoating layer to planarize the color filter layers.

11. The method as claimed in claim 10, further comprising:
forming a second overcoating layer on the first overcoating layer for receiving the color filter layer; and planarizing the second overcoating layer.
